(19) United States
(12) Patent Application Publication
(10) Pub. No.: US 2023/0194439 A1
(43) Pub. Date: Jun. 22, 2023

(54) DEVICE AND METHOD FOR AUTOMATICALLY CHECKING THE QUALITY OF A SPOOL OF THREAD FOR FABRICS

(71) Applicant: THEMA 2 S.R.L., Moglia (IT)

(72) Inventors: Claudio MICHELINI, Moglia (IT); Giovanni GUERZONI, Moglia (IT)

(21) Appl. No.: 17/924,807

(22) PCT Filed: Apr. 28, 2021
(86) PCT No.: PCT/IB2021/053512

§ 371 Date: Nov. 11, 2022

(30) Foreign Application Priority Data
May 12, 2020 (IT) 102020000010720

(51) Int. Cl. G01N 21/952; D06H 3/08; G01N 35/00; B65H 63/00; G06T 7/00

(52) U.S. Cl. CPC G01N 21/952; D06H 3/08; G01N 35/00594; B65H 63/006; G06T 7/001; G01N 2201/062; B65H 2701/31

(57) ABSTRACT

A device for automatically checking quality of a spool of thread for fabrics is provided. The device has at least one vision system provided with a camera, a frame of the camera defining an analysis area, the camera being connectable to a system for moving a spool of thread to be analyzed and to a computer having an analysis software stored thereon, and at least one lighting system having at least one pair of lights arranged facing each other and transversely in relation to the analysis area, each light of the at least one pair of lights having at least one light source for providing a sidelight to the analysis area.

The present invention relates to a device for automatically checking the quality of a spool of thread for fabrics, i.e., a device capable of carrying out the automatic analysis of the physical nature defects of a spool of thread.

In each thread spool production line a step of checking the quality of the spool is provided. Currently, the quality of the spools of thread is checked entirely manually: the operator checks for defects, such as “broken burrs”, “ties” or other morphological defects, simply with the naked eye, using a light source. Once possible defects have been identified, the spools of thread are suitably classified by the operator, who populates a central Database.

The main disadvantage of the manual check lies in that, given the small size of the defects to be found and the similarity between the spools of thread to be checked, the operator returns subjective feedbacks. In particular, the identification of defects and the consequent classification by the operator mainly depends on the experience and competence of the individual, as well as on the ability thereof to maintain a high level of attention and constant concentration throughout the shift, on the time that the operator has available for each spool and on the conditions of the external environment (for example, on the presence or absence of light sources and the mutability thereof).

It is the object of the present invention to solve the issues related to the manual quality check of the spools of thread.

In particular, it is the object of the present invention to provide a device for automatically checking the quality of a spool of thread, capable of carrying out an objective and reliable analysis of the physical nature defects of a spool of thread.

In particular, it is the object of the present invention to provide a device capable of automatically analyzing a spool of thread, recognizing the physical nature defects thereof, such as “broken burrs”, “ties” or other morphological defects, enabling the analysis of the spools to be constantly effective.

Such an object is achieved by a device for automatically checking the quality of a spool of thread for fabrics according to claim 1, by a relative machine according to claim 13, by a relative method for automatically checking the quality of a spool of thread according to claim 16, by a computer according to claim 19 and by a computer program according to claim 20 for implementing the method for automatically checking the quality of a spool of thread. The dependent claims describe preferred embodiments of the invention.

The features and advantages of the device according to the present invention will become apparent from the following description, given by way of non-limiting example in accordance with the accompanying drawings, in which:

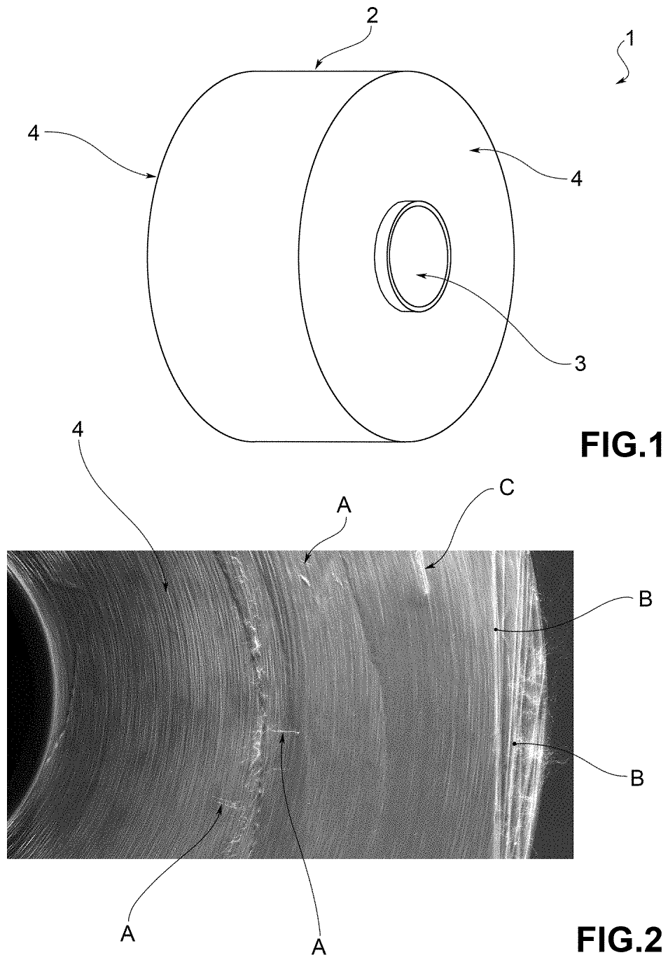

FIG. 1 shows an axonometric view of a thread spool 1;

FIG. 2 shows a front view of a lateral surface 4 of a thread spool 1, in which a series of defects A, B, C are shown;

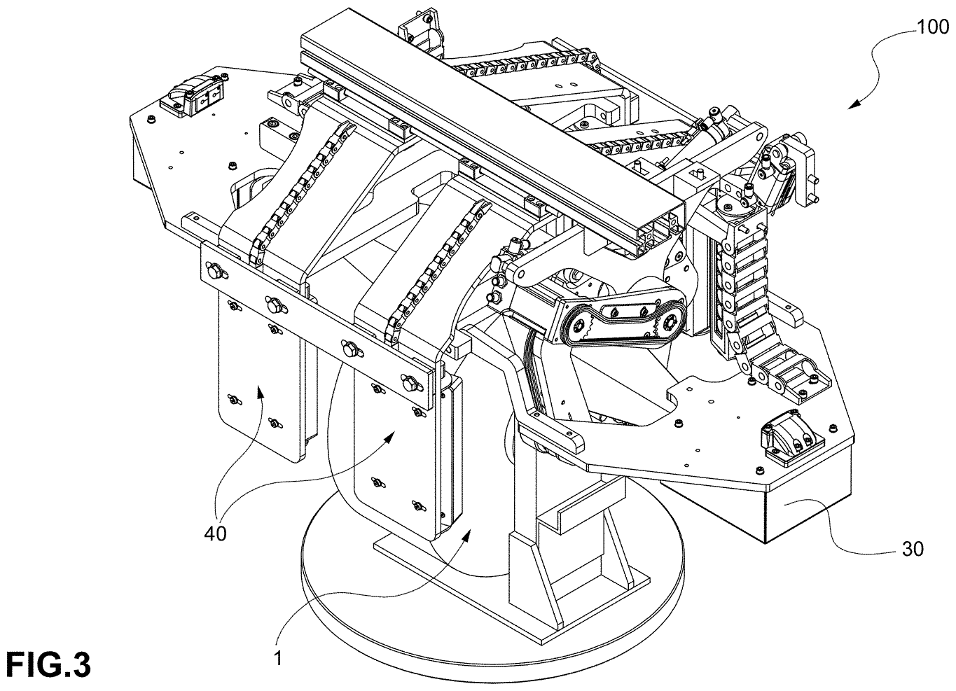

FIG. 3 shows an axonometric view from above of a device 100 for automatically checking the quality of a spool of thread for fabrics, in an embodiment;

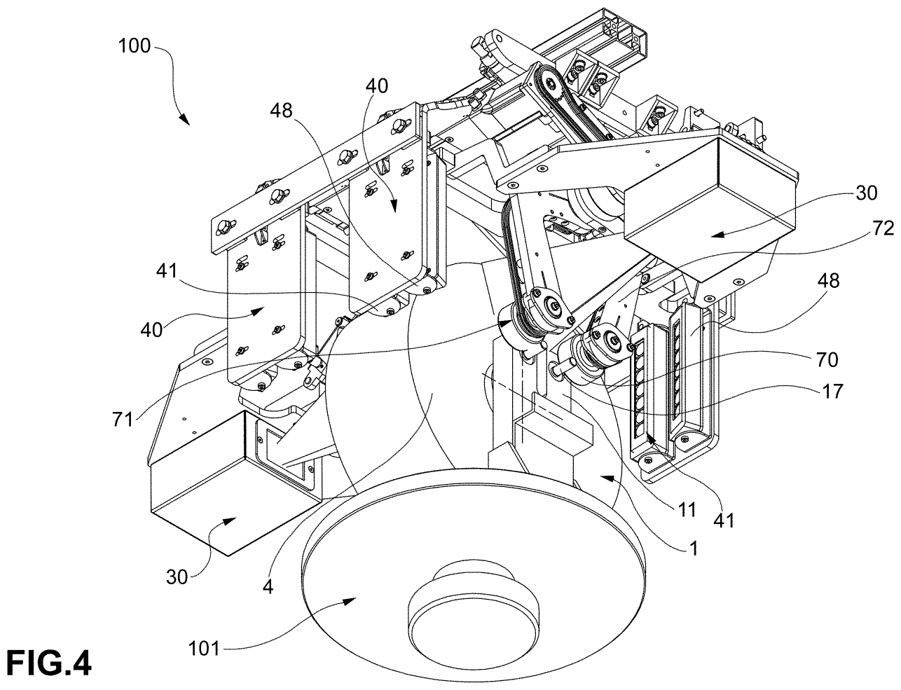

FIG. 4 shows an axonometric view from the bottom of the device in FIG. 3;

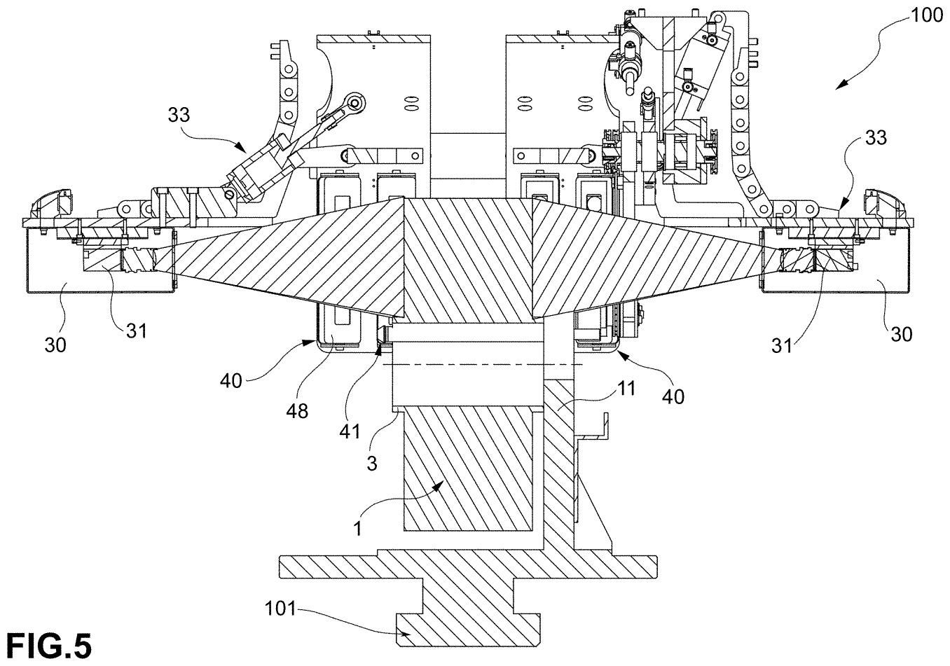

FIG. 5 shows a sectional view of the device in FIG. 3, in a configuration for analyzing the quality of the spool of thread;

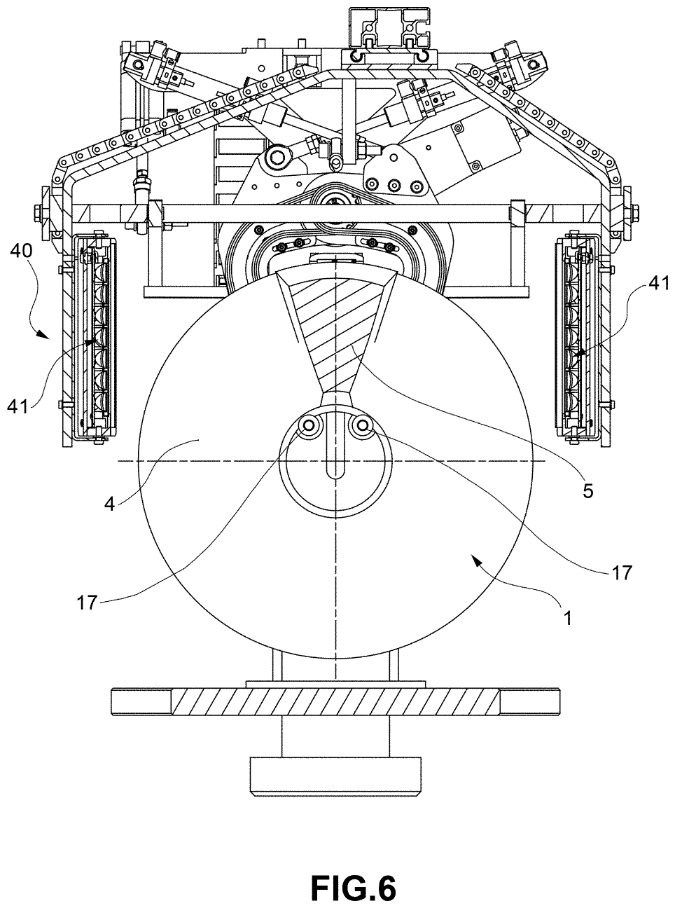

FIG. 6 shows a front view of the device in FIG. 3;

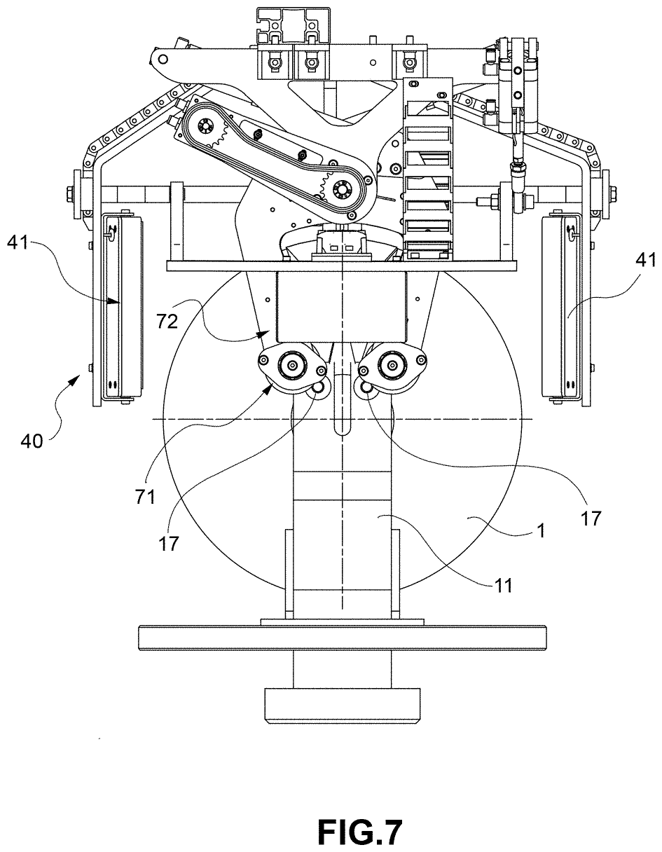

FIG. 7 shows a rear view of the device in FIG. 3;

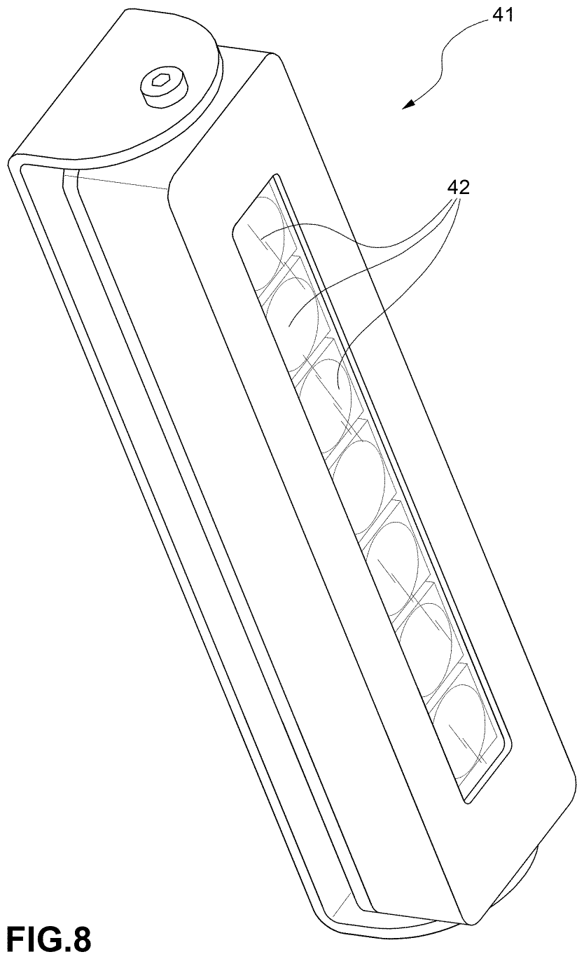

FIG. 8 shows an axonometric view of a light of the device 100 for automatically checking the quality of a spool of thread;

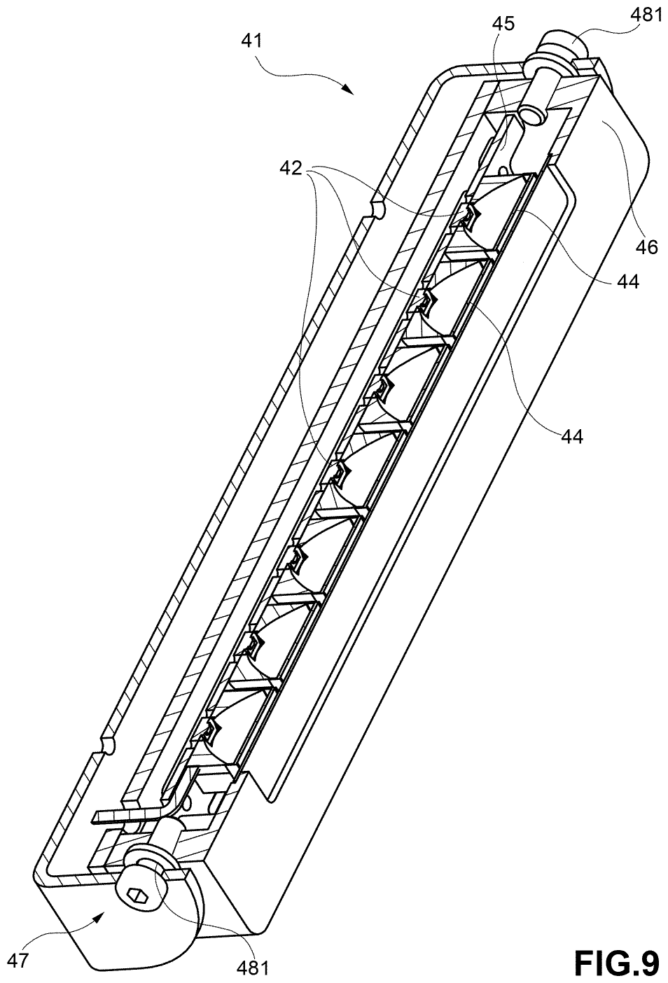

FIG. 9 shows a sectional view of the light in FIG. 8;

FIG. 10 shows an axonometric view from above of a device 100 for automatically checking the quality of a spool of thread for fabrics, in a further embodiment;

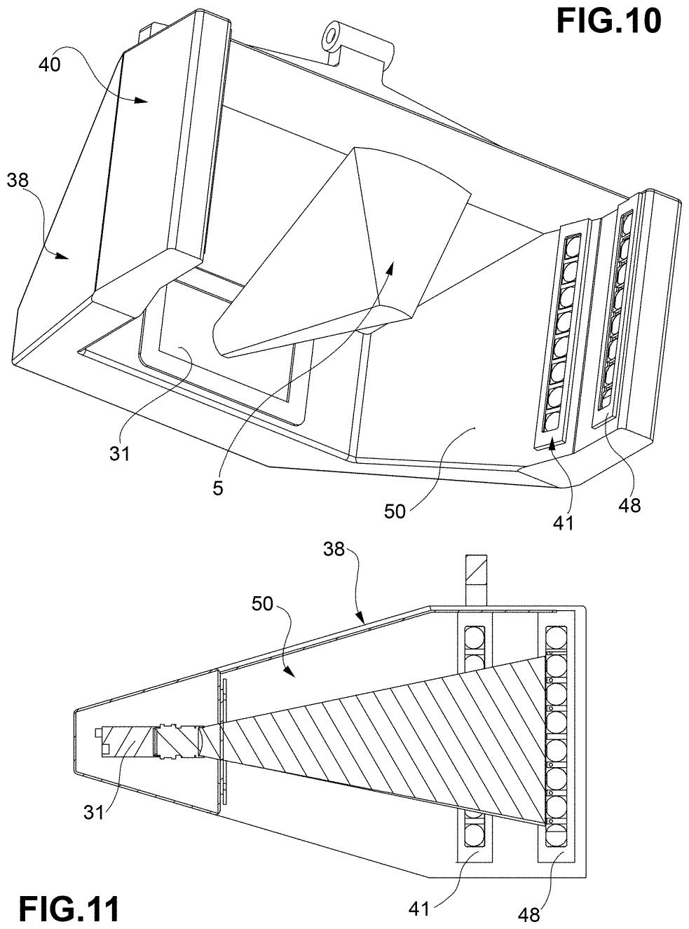

FIG. 11 shows a sectional view of the device in FIG. 10;

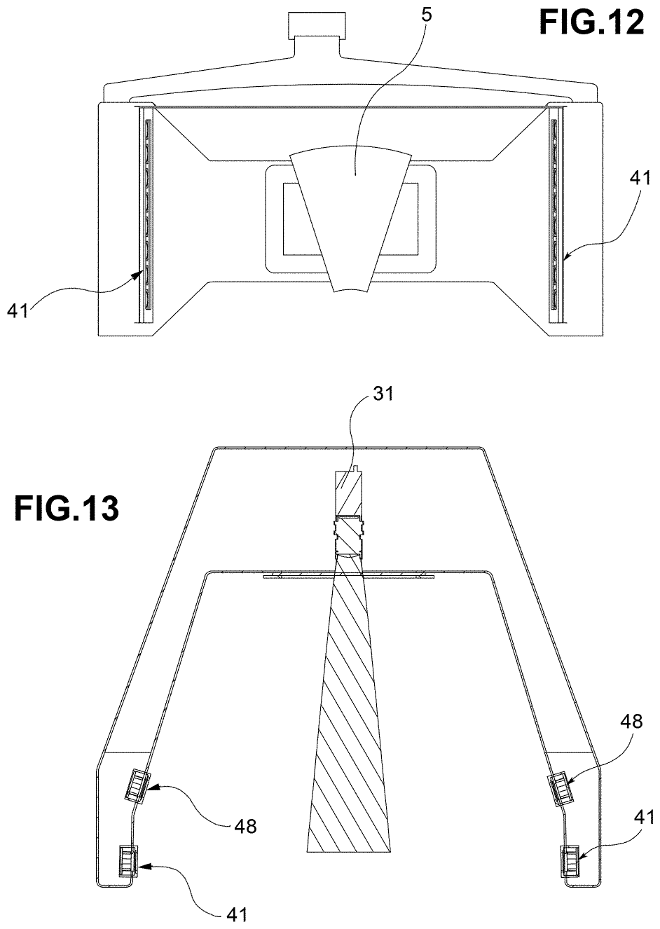

FIG. 12 shows a front view of the device in FIG. 10;

FIG. 13 shows a sectional view from above of the device in FIG. 10;

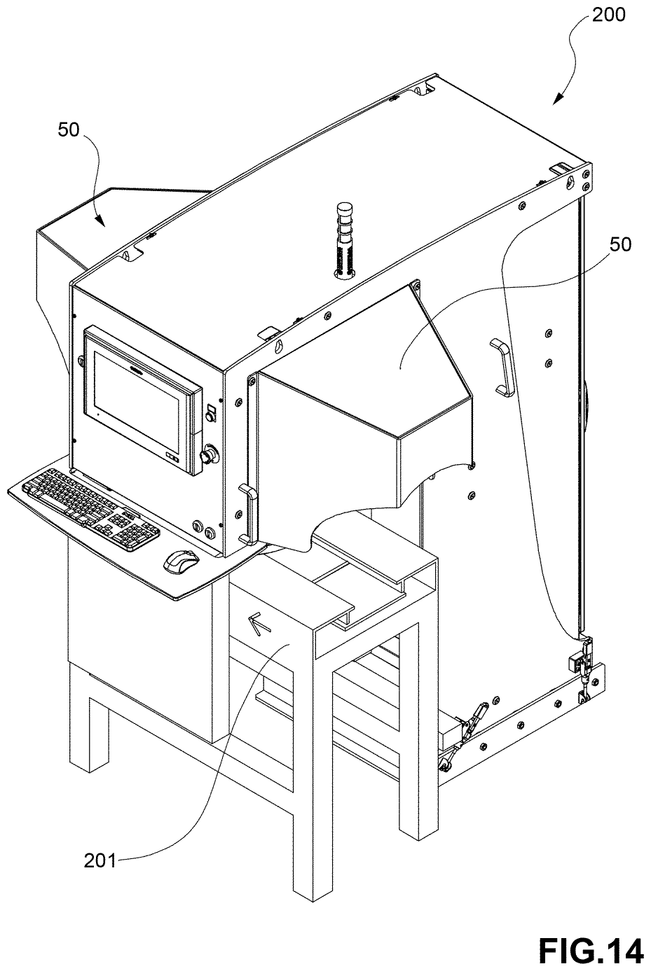

FIG. 14 shows an axonometric view from above of a machine 200, in an embodiment, provided with a device 100 for automatically checking the quality of a spool of thread for fabrics as in FIG. 3;

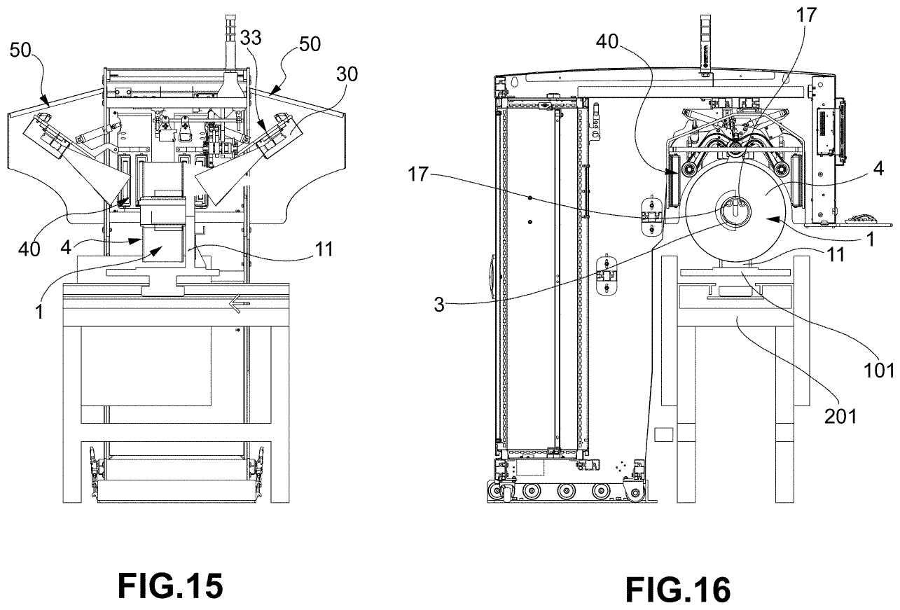

FIG. 15 shows a front sectional view of the machine in FIG. 14, in which the device 100 is in a configuration for replacing the spool of thread;

FIG. 16 shows a lateral sectional view of the machine in FIG. 14.

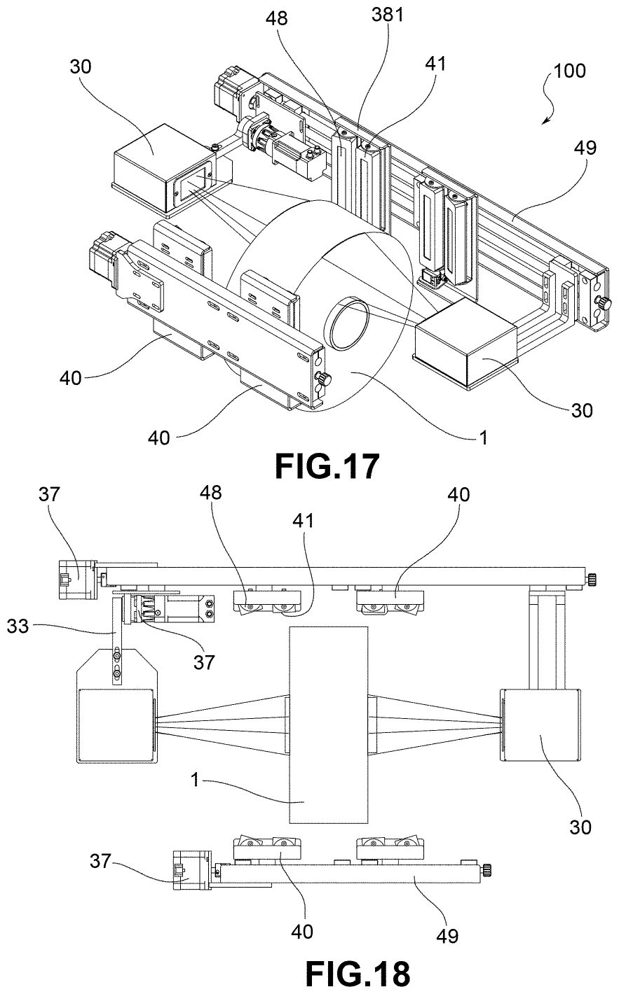

FIG. 17 shows an axonometric view from above of a device 100 for automatically checking the quality of a spool of thread for fabrics, in a further embodiment;

FIG. 18 shows a sectional view of the device in FIG. 17;

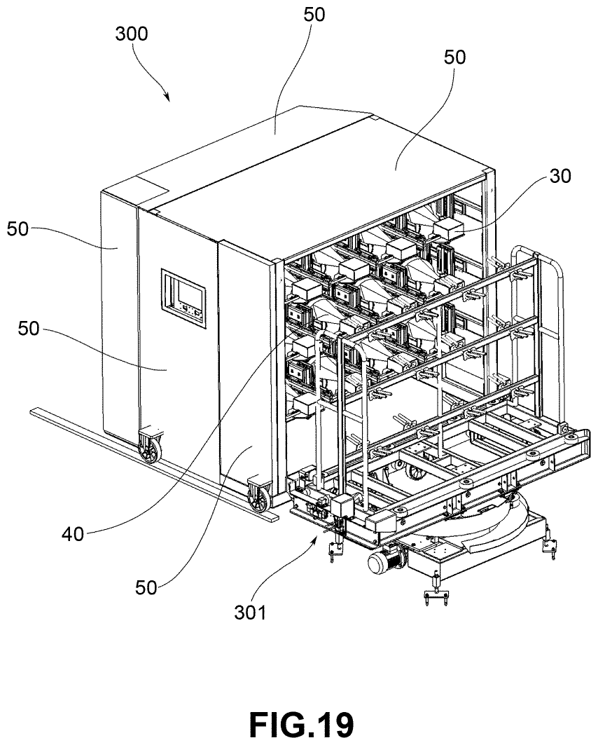

FIG. 19 shows an axonometric view from above of a machine 300, in a further embodiment, provided with a plurality of devices 100 for automatically checking the quality of a spool of thread for fabrics as in FIG. 17;

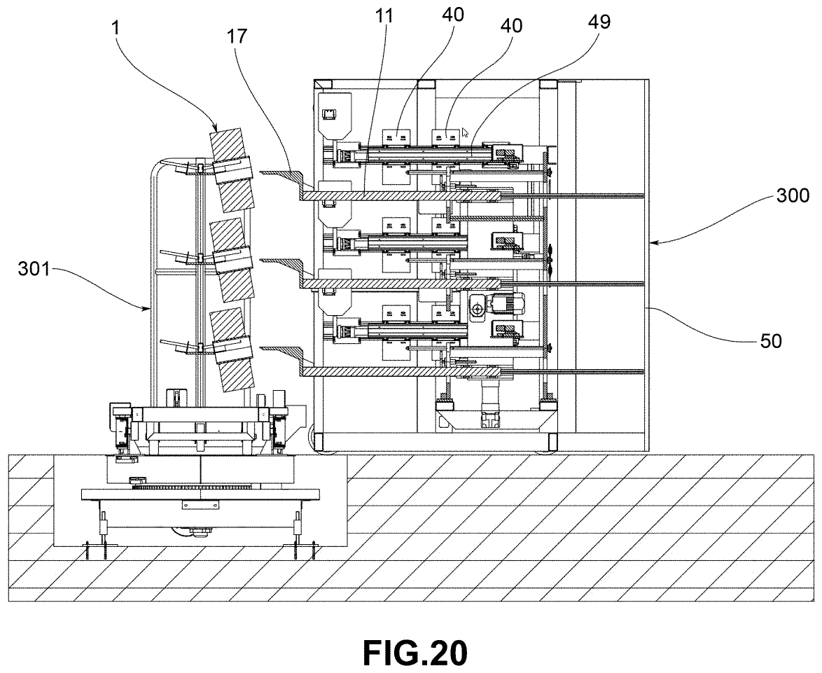

FIG. 20 shows a sectional view of the machine in FIG. 19 during the step of loading the spools, for example from a trolley;

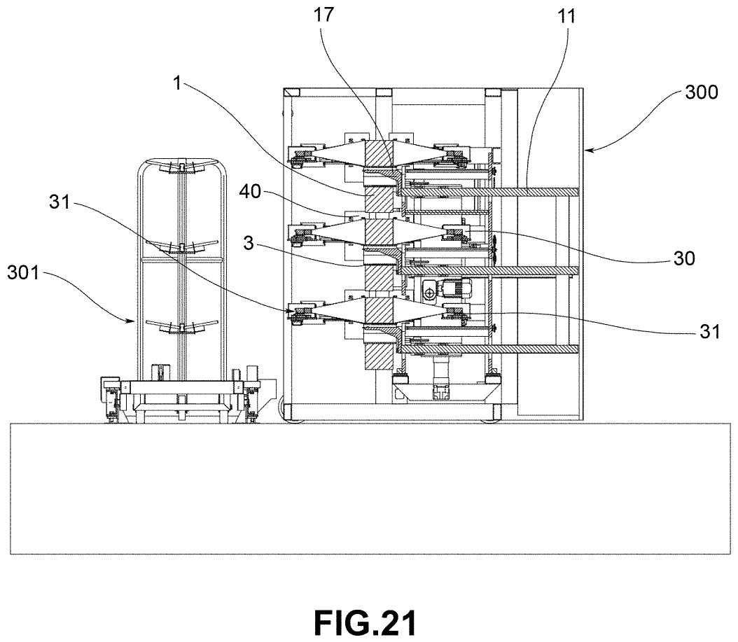

FIG. 21 shows a sectional view of the machine in FIG. 19 with the spools loaded and being analyzed;

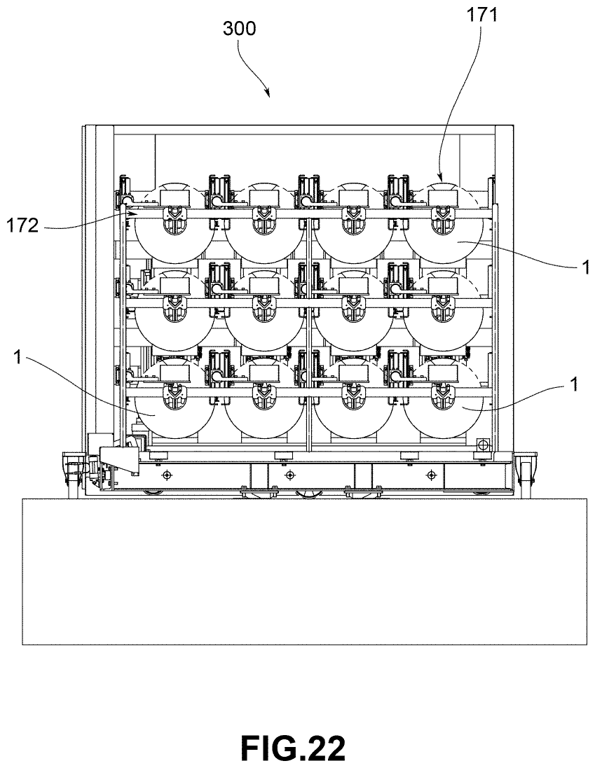

FIG. 22 shows a front view of the machine in FIG. 19 with the spools loaded.

With reference to the above Figures, in particular to FIGS. 1 and 2, some definitions useful for understanding the invention are given below.

Tube 3: cylinder onto which the thread for forming a thread spool 1 is wound; it is often made of plastic or cardboard material.

Thread spool 1: it is obtained by winding a thread, accompanying it over a tube 3, maintaining a cylindrical symmetry. For mechanical-textile reasons, the thread spool 1 may have different profiles according to the physical-chemical nature of the thread collected.

External surface 2 of the thread spool 1: it corresponds to the front face of the spool of thread, i.e., the face at which the winding of the thread on the tube 3 occurs.

Lateral or Tapered Surfaces 4 of the thread spool 1: they correspond to the sides of the spool of thread, and represent the surfaces of interest of the system according to the present invention.

Defects present on the Lateral or Tapered surfaces 4 of the thread spool 1, and of interest for the system according to the present invention:

“Broken Burr” defect A: it is a thread-like body which protrudes from the lateral surface of the spool of thread.

“Tie” defect B: it is a portion of thread of the spool which does not respect the correct positioning. The portion of thread protrudes and then re-enters from the lateral surface of the spool of thread, due to an incorrect positioning of the thread during the step of forming the spool of thread.

Other morphological defects C: a perfect spool of thread shall have lateral surfaces on which other shapes are not distinguishable except the circular thread winding weft. Anything that differs, i.e., which may be distinguished from such a circular winding weft, is considered a defect and must be recognized.

With reference to the accompanying drawings, and in particular to FIGS. 3, 10 and 17, reference numeral 100 overall indicates a device for automatically checking the quality of a spool of thread for fabrics.

The device 100 for automatically checking the quality of a thread spool 1 according to the present invention may be an integral part of a machine 200, 300 for automatically checking the quality of a thread spool 1, or it may be applied (as an accessory) to a pre-existing machine 200 for automatically checking the quality of a thread spool 1. An example of machine 200 for automatically checking the quality of a thread spool 1 is shown in FIG. 14. A further example of machine 300 for the multiple automatic check of the quality of a plurality of spools of thread 1 is shown in FIG. 19.

The device 100 for automatically checking the quality of a thread spool 1, or the machine 200, 300 integrating or mounting the device 100, or the plate 101 on which the spool is loaded, comprises at least one frame 11 which supports an arm 17 onto which it is possible to place the thread spool 1 to be analyzed.

The device 100 comprises at least one vision system 30 and at least one dedicated lighting system 40.

In the embodiment in which the device 100 comprises a vision system 30 and a corresponding dedicated lighting system 40, it is possible to analyze only a lateral surface 4 of the spool of thread.

In the embodiment in FIGS. 4, 10 and 17 in which the device 100 comprises a pair of vision systems 30 and a pair of corresponding dedicated lighting systems 40, it is possible to simultaneously analyze both lateral surfaces 4 of the spool of thread.

The vision system 30 analyzes an analysis area 5, defined as a portion of the lateral surface 4 of the thread spool 1. Preferably, the analysis area 5 corresponds to a segment of the lateral surface 4, and extends from the tube 3 for the entire vertical development of the thread spool 1.

The vision system 30 comprises a digital camera 31 connected to a computer on which a dedicated analysis software is loaded.

The camera 31 is therefore arranged frontally in relation to the lateral surface 4 of the thread spool 1 to be analyzed.

The lighting system 40 is made so as to emphasize the presence of the above defects, therefore the “Broken Burr” defects A, “tie” defects B and other morphological defects C. It is in fact the object of the lighting system 40 to illuminate with direct light the parts which protrude from the lateral surface 4 and which are therefore defects, and to instead illuminate, mainly with diffused light, the lateral surface 4 itself.

The lighting system 40 is therefore made so as to provide an illumination which substantially hits the lateral surface 4 of the spool of thread sidewise, so as to highlight the defects thereof.

The lighting system 40 comprises at least one pair of lights 41, shown in detail in FIGS. 8 and 9.

The lights 41 are therefore arranged substantially transversely in relation to the lateral surface 4 of the thread spool 1 to be analyzed, and project thereon a light beam which substantially hits the lateral surface 4 itself sidewise.

Each light 41 preferably comprises a series of light sources 42, preferably a series of high-intensity LEDs. Preferably, the light sources 42 are arranged in line.

It should be noted that the number of light sources 42 contained in the light 41 depends on the size of the analysis area 5 of the vision system 30: the entire height of the analysis area 5 shall be illuminated.

Preferably, each light source 42, i.e., each LED, is provided with a cylindrical lens 44 that conveys the light beam towards the analysis area 5.

The light 41 preferably comprises a light-polarization filter.

The light 41 preferably comprises a high-efficiency heat diffusion system. Preferably, the series of light sources 42 are fixed on a metal plate 45 positioned in direct contact with the protective metal casing 46.

Preferably, the light 41 is directable. The light 41, in fact, comprises a base 47 which may be connected to the device 100, and the protective casing 46 is fixed in a rotatable manner (for example, by means of a pair of pins 48) in relation to such a base 47.

The lighting system 40 comprises two lights 41, positioned on the opposite sides of the lateral surface 4 of the thread spool 1.

Preferably, the two lights 41 are positioned opposite to each other.

Preferably, the two lights 41 are side lights, positioned at an angle between 0° and 15° in relation to the lateral surface 4 of the thread spool 1.

It should be noted that the angle of 0° degrees corresponds to the situation of parallelism between the lateral surface 4 of the thread spool 1 and the light beam emitted by the light 41.

In an embodiment, the lighting system 40 comprises two lights 41, positioned on opposite sides of the lateral surface 4 of the thread spool 1, positioned at an angle of 0° and 15° in relation to the lateral surface 4 of the thread spool 1.

The lighting system 40 further comprises two additional lights 48, positioned on the opposite sides of the lateral surface 4 of the thread spool 1.

Preferably, the two lights 48 are positioned opposite to each other.

Preferably, the two lights 48 are angled lights, positioned at an angle between 10° and 60° in relation to the lateral surface 4 of the thread spool 1.

The further, so-called, angled lights 48 are of the same type as the side lights 41, but they are arranged at a more frontal angle and distance. The purpose is to be capable of analyzing even very dark spools of thread and looking for defects other than morphological ones, for example color defects.

Preferably, the device 100, comprises a shield 50 suitable to cover at least partly the vision system 30 and/or the lighting system 40 and/or the analysis area 5 of the lateral surface 4 of the thread spool 1. Advantageously, in fact, the thread spool 1 is analyzed inside a dark chamber, obtained by means of the shield 50, which protects it from other unwanted light sources.

Preferably, the camera 31 is protected by a container 30 and by an optical glass placed between the lens and the spool. The faces of the glass and the paste must be processed with very high quality.

It should be noted that the exposure time of each photographic shot made by the vision system 30 is calculated for each thread spool 1 analyzed, so as to mediate the shade of gray of the obtained image.

Preferably, at least the camera 31 of the vision system 30 is movable, i.e., it may be moved away from the arm 17 on which the thread spool 1 is positioned so as to create space to facilitate the replacement of the spools.

In the example in FIG. 5, the camera 31 is fixed to a moving arm 33 which allows it to be raised, when it is necessary to replace the spool of thread, and to be lowered back into the operating position, when it is necessary to analyze the spool of thread.

In the example in FIG. 17, the camera 31 is fixed to a moving arm 33 which allows it to be moved longitudinally along the axis of the spool, towards and away from it, when it is necessary to replace the spool of thread.

Preferably, both the vision system 30 and the lighting system 40 are movable, i.e., they may be moved away from the arm 17 on which the thread spool 1 is positioned, so as to create a space to facilitate the replacement of the spools or to adjust the vision system and the lighting system for a correct analysis of the spool.

In the example in FIG. 10, both the camera 31 and the lights 41, 48 are fixed on a movable frame 38 which allows it to be raised, when it is necessary to replace the spool of thread, and to be lowered back into the operating position, when it is necessary to analyze the spool of thread. In such an embodiment, the movable frame 38 also comprises a shield 50 suitable to cover at least partly the vision system 30 and/or the lighting system 40 and/or the analysis area 5 of the lateral surface 4 of the thread spool 1.

In the example in FIG. 17, both the camera 31 and the lights 41,48 are slidable along a track 49 which allows it to be moved along the axis of the spool, towards and away from the spool of thread, when it is necessary to replace it. In such an embodiment, the camera 31 is fixed to an arm 33 and the lights 41, 48 are fixed to a trolley 38, both the arm 33 and the trolley 38 being slidable along the track. Preferably, the arm 33 and the trolley 38 are moved by a relative motor 37.

Preferably, the device 100 further comprises an automatic system for moving the thread spool 1, shown, for example, in FIG. 4. The moving system 70 comprises at least one roller 71 adapted to rotate the support pin 17 on which is the thread spool 1 is arranged. In the example in FIG. 7, in which the spool is positioned on a pair of support pins 17, the moving system 70 comprises a pair of rollers 71 each adapted to rotate a relative support pin 17.

Preferably, the rollers 71 are movable by means of suitable moving arms 72.

An example of machine 200 for automatically checking the quality of a thread spool 1 is shown in FIG. 14.

The machine 200 comprises a frame 11 which supports an arm 17 (or pin 17) on which it is possible to place a thread spool 1 to be analyzed.

The machine 200 for automatically checking the quality of a spool of thread, in accordance with the present invention, comprises:
a frame 11 provided with an arm 17 onto which a spool of thread to be analyzed may be placed;
a system for moving the spool of thread to be analyzed;
a computer onto which analysis software is loaded;
a device 100 for automatically checking the quality of the spool of thread to be analyzed, connected to the system for moving the spool and to the computer.

Preferably, the machine 200 also comprises a shield 50 suitable to cover at least partly the vision system 30 and/or the lighting system 40 and/or the analysis area 5 of the lateral surface 4 of the thread spool 1.

Preferably, the machine 200 includes a loading system of the “plate” type, as shown in FIGS. 4 and 14.

The plate 101 is a mechanical device which supports the spool on two pins 17 (also shown in FIG. 6) and which may be conveyed along a conveyor belt 201 (partially shown in FIG. 14).

The plate 101 comprises a frame 11 which supports a pair of arms 17 on which the thread spool 1 to be analyzed travels.

The plate 101 is arranged on the conveyor belt so that the relative tube 3 is positioned horizontally, transversely in relation to the conveying plane defined by the conveyor belt 201 (as shown in FIG. 16).

The conveyor belt 201 moves the plate 101 up to a mechanical stop positioned inside the analysis chamber of the machine 200. Once the plate 101 has reached the destination thereof, the belt 201 is blocked.

The rollers 71 (for example, in the form of rubber wheels) are therefore lowered until they come into contact with and press the support pins 17 and are kept in contact by pressure. When the rollers 71 begin to rotate synchronously, they transmit, by friction, the motion to the tube 3 and therefore to the spool 1 which also begins to rotate.

The vision systems 30 descend until each is positioned facing a lateral face 4 of the thread spool 1, so as to be capable of framing the whole analysis area 5.

When the device 100 provides for it (such as, in FIG. 10), also the lighting systems 40 descend until they are positioned each on one side of the lateral face 4 of the thread spool 1, so as to correctly illuminate the analysis area 5.

The vision systems 30 and the lighting systems 40 are adjusted in position according to the size of the spool.

While the thread spool 1 rotates, a photograph is taken of the analysis area 5 of each lateral face 4. Preferably, the photographs of the two lateral faces 4 of the thread spool 1 are taken in a staggered manner, first one and then the other, to prevent the lighting systems 40 of each lateral face 4 from interfering with each other.

Once a complete rotation (hence 360 degrees) of the thread spool 1 has been completed, and, therefore, once the photographs of the entire circumference of both lateral faces 4 of the spool of thread have been taken, the vision systems 30 (and possibly the lighting systems 40, depending on the type of device 100) are raised again.

When the path is free, the conveyor belt is moved to allow the exit of the plate 101 on which the spool of thread just analyzed is arranged, and to allow the entry of the next plate on which a spool of thread still to be analyzed is arranged.

A further example of machine 300 for the multiple automatic check of the quality of a plurality of spools of thread 1 is shown in FIG. 19.

The machine 300 comprises a frame 11 which supports a plurality of arms 17 (or pins 17) on each of which it is possible to place a thread spool 1 to be analyzed. The machine 300 therefore allows the multiple automatic check of a plurality of spools of thread 1. In the example in FIG. 22, precisely given by way of non-limiting example, the machine 300 is capable of automatically checking 12 spools of threads simultaneously.

The machine 300 for the multiple automatic check of the quality of a spool of thread, in accordance with the present invention, comprises:
a frame 11 provided with at least one arm 17, preferably a plurality of arms 17, on each of which it is possible to place a spool of thread to be analyzed;
a plurality of moving systems, each connected to a spool of thread to be analyzed;
at least one computer onto which analysis software is loaded;
a plurality of devices 100, each intended for automatically checking the quality of a spool of thread, connected to the respective spool moving system, and to at least one computer.

The frame 11 of the machine 300 comprises at least one arm 17 on which a thread spool 1 may be loaded. Preferably, the frame 11 comprises a plurality of arms 17 arranged to form at least one column 171 and/or at least one horizontal row 172 on which the spools of thread may be positioned.

Preferably, the frame 11 comprises a plurality of columns 171 and/or horizontal rows 172.

Preferably, the machine 300 also comprises a shield 50 suitable to cover at least partly the vision systems 30 and/or the lighting systems 40 and/or the analysis areas 5 of the spools of thread 1.

Preferably, the machine 300 includes a loading system of the “trolley” type, as shown in FIGS. 17 and 20.

The trolley 301, clearly visible in FIG. 19, supports at least one thread spool 1, preferably a plurality of columns of spools of thread and/or a plurality of horizontal rows of spools of thread.

The trolley 301, also called module, is conveyed along the moving line up to the machine 300.

The spools are loaded, from the trolley 301 itself, inside the analysis chamber of the machine 300. In particular, the spools of thread are loaded each on a relative arm 17.

The vision systems 30 descend until each is positioned facing a lateral face 4 of the thread spool 1, so as to be capable of framing the whole analysis area 5.

When the device 100 provides for it (such as, in FIG. 18), also the lighting systems 40 descend until they are positioned each on one side of the lateral face 4 of the thread spool 1, so as to correctly illuminate the analysis area 5.

The vision systems 30 and the lighting systems 40 are adjusted in position according to the size of the spool.

While the thread spool 1 rotates, a photograph is taken of the analysis area 5 of each lateral face 4. Preferably, the photographs of the two lateral faces 4 of the thread spool 1 are taken in a staggered manner, first one and then the other, to prevent the lighting systems 40 of each lateral face 4 from interfering with each other.

Once a complete rotation (hence 360 degrees) of the thread spool 1 has been completed, and, therefore, once the photographs of the entire circumference of both lateral faces 4 of the spool of thread have been taken, the vision systems 30 (and possibly the lighting systems 40, depending on the type of device 100) are raised again.

When the path is free, the trolley 301 unloads the spools of thread just analyzed and a new trolley 301 loads the spools of thread still to be analyzed.

The device 100 for automatically checking the quality of the spool of thread allows to analyze the spool by means of the lights 41, 48, an automation cycle and a dedicated software. The lights adequately illuminate (sidelight) the surface of the spool of thread, the automation cycle allows to obtain adequate images of the spool of thread and the software processing allows the extrapolation of defects.

It should be noted that the device 100 has been designed so as to fit an already present automation context.

The present invention also relates to a method for automatically checking the quality of a spool of thread for fabrics.

The method in accordance with the present invention comprises at least the following steps:
providing at least one device 100 for automatically checking the quality of the spool of thread to be analyzed as described above;
turning on the pair of lights 41, 48 of the device 100 to illuminate the analysis area 5 while taking a photograph of the spool of thread corresponding to the analysis area 5 by means of the camera 31 of the device 100;
extrapolating the defects from the photograph of the spool of thread corresponding to the analysis area 5 by means of an extrapolation algorithm.

In particular, the extrapolation algorithm is run by a computer and involves at least the following steps:
scanning the photograph of the spool of thread corresponding to the analysis area;
extracting the four polarization planes of the photograph identified by the angles 0°, 45°, 90° and 135°;
subtracting the image obtained from one polarization plane from an image obtained from another polarization plane, so as to highlight the differences in the morphology of the lateral surface of the spool;
converting the weft of the image from circular to linear;
identifying all of the sets of pixels that may potentially be categorized as defective;
applying parameterizable filters to all of the sets of pixels, so as to rule out false negatives;
checking, for example by means of the morphological expansion method, whether pixels near a set of pixels categorized as defective are themselves part of said set;
if pixels near a set of pixels categorized as defective are themselves part of said set, combining said pixels near said set of pixels categorized as defective.

In particular, the step of identifying all of the sets of pixels that may be categorized as faulty comprises at least the sub-steps of:
defining defect parameters suitable for characterizing the defects obtained from the extrapolation algorithm, for example size, shape, direction, luminosity, microcontrasts, and anisometry;
taking from the pixels obtained from the step of converting the weft of the image from circular to linear the values taken by said defect parameters;
comparing said values with the values of corresponding parameters of defects contained in a database of previously categorized defective images;
categorizing the defect on the basis of the minor difference between the values of the defect parameters and the corresponding values of said previously categorized defects.

The automation cycle, the extrapolation of defects from the saved image and the recognition of the type of defect by means of the neural network will now be described in detail.

### Automation Cycle:

1. The thread spool 1 already mounted to the support pins 17 is moved by the conveyor belt.

2. The system recognizes the presence of the thread spool 1 inside the analysis area, therefore it blocks it with a mechanical stop.

3. The rollers 71 are lowered onto the support pins 17 and are kept in contact by pressure. At the same time, the two cameras 31, which frame the two lateral faces 4 of the thread spool 1, are lowered.

4. A single motor rotates the rollers 71 and therefore the thread spool 1.

5. An encoder or a resolver allows to know the rotation angle performed. A photograph of the spool of thread is taken (corresponding to the analysis area 5) and a sector of the circular crown is thus analyzed, having the circumference of the tube as the smallest one, the circumference of the spool as the largest one, and the sides of the angle of 30°, which starts from the center of the spool, as ends thereof.

6. Each time a photograph is taken, the dedicated lights 41, 48 are controlled.

7. The two lateral faces 4 of the thread spool 1 are analyzed simultaneously; in order not to affect the lighting of one over the other, the photographs are taken in an asynchronous manner, for example with a delay of 15°.

8. Once the 360° of the spool have been completed, the rollers 71 and the cameras 31 are raised again; the spool of thread is therefore released to allow it to continue the travel thereof along the conveyor belt.

Extrapolation of Defects from the Saved Image

The method for using the device 100 includes the application in an ordered sequence of the following algorithms:

1. Polarization filter: the 4 polarization planes are extracted, and the cleaner image is then reconstructed.

2. Frequency filter: the image is converted into the frequency spectrum using the Fourier Transform algorithm. After applying a high pass filter, it is reverted from spectrum to geometric image.

3. Polarization difference filter: the luminance map of the image is constructed by performing successive subtractions of the 4 polarization planes. Thus, only what is not aligned with the general weft emerges.

4. Smoothing process.

5. The image is modeled so that the trend of the weft changes from circular to linear. Thus, off-weft defects emerge.

6. Numerical and geometric filters: other suitably set mathematical filters are applied, for example, the brightness of the pixels found and the minimum size in pixels.

7. Of all the groups of pixels recognized as defective, a single defect is reconstructed by composing all the pixels which are close to each other and which maintain the permitted geometries.

### Recognition of the Type of Defect by Means of the Neural Network

The vision system categorizes the defects following a logic of the Neural Network type.

A Database of images already labeled by an operator is built. The order of magnitude of this collection must be at least of a few hundred images. Each image provides plenty of information, for example, the size of the defect, the shape, the direction, the brightness.

Once a defect has been detected, the system searches for the closest match, by comparing all the information, and classifies it.

Thereby, the system automatically discriminates, for example, a “broken burr” defect from a “tie” defect. The user may therefore weigh each defect to obtain an overall evaluation of the analyzed spool.

The present invention also relates to a computer programmed to implement the method for automatically checking the quality of a spool of thread for fabrics as described above.

The present invention also relates to a computer program comprising portions of code which, when the program is run on a computer, implement the method for automatically checking the quality of a spool of thread for fabrics as described above.

Innovatively, a device 100 for automatically checking the quality of a thread spool 1, and the related automatic checking method, allows the analysis carried out on the spool to be objective, and therefore to make the assessment and the classification objective and error-free.

Advantageously, therefore, the device and the method described herein allow to completely automate the analysis and classification of the spools, with the dual purpose of ensuring absolute objectivity in the assessment and reducing the cost of complaints and consequent penalties. Such an aspect is very important, especially for high-end product categories.

It is apparent that those skilled in the art may make changes to the subject described above, all contained within the scope of protection as defined by the following claims.

1-20. (canceled)

21. A device for automatically checking quality of a spool of thread for fabrics, the device comprising:
at least one vision system comprising a camera, a frame of the camera defining an analysis area, the camera being connectable to a system for moving a spool of thread to be analyzed and to a computer having an analysis software stored thereon; and
at least one lighting system;
wherein the at least one lighting system comprises:
at least one pair of lights arranged facing one another and transversely in relation to the analysis area, each light of the at least one pair of lights comprising a plurality of light sources arranged in line, each light source of the plurality of light sources being suitable for providing a raking light to the analysis area of the camera, and
an additional pair of lights arranged facing one another and transversely in relation to the analysis area, each light of the additional pair of lights comprising a plurality of light sources arranged in line, each light source of the plurality of light sources being suitable for providing an angled illumination to the analysis area.

22. The device of claim 21, wherein lights of the at least one pair of lights are positioned at an angle of between 0° and 15° in relation to the analysis area, wherein the angle of 0° corresponds to a parallelism between illumination provided by the light source and the analysis area.

23. The device of claim 21, wherein lights of the additional pair lights are positioned at an angle of between 10° and 60° in relation to the analysis area.

24. The device of claim 21, wherein each light source is a high-intensity LED.

25. The device of claim 21, wherein each light source is provided with a cylindrical lens that conveys a light beam towards the analysis area.

26. The device of claim 21, wherein lights of the at least one pair of lights and of the additional pair of lights comprise a light-polarization filter.

27. The device of claim 21, wherein lights of the at least one pair of lights and of the additional pair of lights comprise a heat diffusion system in the form of a metal plate onto which the light sources are fixed, the metal plate being fixed to a metal protective casing.

28. The device of claim 21, wherein lights of the at least one pair of lights and of the additional pair of lights are rotatable to enable orientation of the light sources in relation to the analysis area.

29. The device of claim 21, further comprising a shield for at least partly covering at least one of the vision system, the lighting system, the analysis area.

30. The device of claim 21, comprising a pair of vision systems and a pair of lighting systems, wherein two cameras are arranged facing one another.

31. A machine for automatically checking quality of a spool of thread, the machine comprising:
a frame provided with at least one arm for receiving a spool of thread to be analyzed;
at least one system for moving the spool of thread to be analyzed;
a computer having an analysis software stored thereon; and
at least one device for automatically checking quality of the spool of thread to be analyzed, the at least one device comprising:
at least one vision system comprising a camera, a frame of the camera defining an analysis area, the camera being connectable to a system for moving a spool of thread to be analyzed and to a computer having an analysis software stored thereon; and
at least one lighting system;
wherein the at least one lighting system comprises:
at least one pair of lights arranged facing one another and transversely in relation to the analysis area, each light of the at least one pair of lights comprising a plurality of light sources arranged in line, each light source of the plurality of light sources being suitable for providing a raking light to the analysis area of the camera, and
an additional pair of lights arranged facing one another and transversely in relation to the analysis area, each light of the additional pair of lights comprising a plurality of light sources arranged in line, each light source of the plurality of light sources being suitable for providing an angled illumination to the analysis area, said device being connected to the at least one system for moving the spool of thread to be analyzed and to the computer.

32. The machine of claim 31, wherein the at least one vision system and/or the at least one lighting system are movable away and/or towards the at least one arm.

33. The machine of claim 31, wherein the frame comprises a plurality of arms arranged to form at least one column and/or at least one horizontal row for positioning the spool of thread.

34. A method for automatically checking quality of a spool of thread for fabrics, the method comprising:
providing at least one device for automatically checking quality of a spool of thread to be analyzed, the at least one device comprising:
at least one vision system comprising a camera, a frame of the camera defining an analysis area, the camera being connectable to a system for moving a spool of thread to be analyzed and to a computer having an analysis software stored thereon; and
at least one lighting system;
wherein the at least one lighting system comprises:
at least one pair of lights arranged facing one another and transversely in relation to the analysis area, each light of the at least one pair of lights comprising a plurality of light sources arranged in line, each light source of the plurality of light sources being suitable for providing a raking light to the analysis area of the camera, and
an additional pair of lights arranged facing one another and transversely in relation to the analysis area, each light of the additional pair of lights comprising a plurality of light sources arranged in line, each light source of the plurality of light sources being suitable for providing an angled illumination to the analysis area;
turning on the least one pair of lights and the additional pair of lights to illuminate the analysis area and at the same time take a photograph of the spool of thread corresponding to the analysis area by the camera; and
extrapolating defects from the photograph of the spool of thread corresponding to the analysis area by an extrapolation algorithm.

35. The method of claim 34, wherein the extrapolation algorithm is performed by a computer and the step of extrapolating defects comprises:
scanning the photograph of the spool of thread corresponding to the analysis area;
extracting four polarization planes of the photograph identified by angles 0°, 45°, 90° and 135°;
subtracting an image obtained from one polarization plane from an image obtained from another polarization plane, to highlight differences in morphology of a lateral surface of the spool;
converting a weft of the image from circular to linear;
identifying all sets of pixels categorizable as defective;
applying parameterizable filters to all of the sets of pixels, so as to rule out false negatives; and
checking whether pixels near a set of pixels categorized as defective are part of said set;
if the pixels near the set of pixels categorized as defective are part of said set, combine the pixels near the set of pixels categorized as defective.

36. The method of claim 35, wherein the step of identifying all sets of pixels categorizable as defective comprises at least the sub-steps of:
defining defect parameters suitable for characterizing the defects obtained from the extrapolation algorithm;
taking from pixels obtained from the step of converting the weft of the image from circular to linear values of the defect parameters;
comparing the values of the defect parameters with values of corresponding defect parameters contained in a database of previously categorized defective images; and
categorizing the defects on minor difference between the values of the defect parameters and the values of the corresponding defect parameters of the previously categorized defective images.

37. The method of claim 36, wherein the defect parameters comprise size, shape, direction, luminosity, microcontrasts and anisometry.
